(19) United States
(12) Patent Application Publication
(10) Pub. No.: US 2005/0138643 A1
(43) Pub. Date: Jun. 23, 2005

(54) System and method for controlling a computer operating environment using a scripting language-based computer program

(76) Inventors: Denny Jaeger, Oakland, CA (US); Christopher John Guyler, Cambridge (GB)

Correspondence Address: Wilson & Ham, PMB: 348, 2530 Berryessa Road, San Jose, CA, 95132, US

(21) Appl. No.: 10/740,734

(22) Filed: Dec. 18, 2003

(51) Int. Cl. G06F 13/00; G06F 9/44

(52) U.S. Cl. 719/320; 717/115

(57) ABSTRACT

A system and method for controlling a computer operating environment utilizes a non-executable computer program that is dependent on a primary computer program, which provides the computer operating environment. The non-executable computer program is a compiled computer program that is based on a custom scripting programming language. The non-executable computer program can be configured to control various aspects of the computer operating environment using a bytecode interpreter of the primary computer program, including any object that can exist in the computer operating environment.

### FIELD OF THE INVENTION

The invention relates generally to computer programs, and more particularly to a system and method for controlling a computer operating environment.

### BACKGROUND OF THE INVENTION

Due to the wide use of computers, numerous types of computer applications are now in the consumer marketplace. These computer applications include audio and video applications, Internet-related applications (e.g., browsers, communication tools, and ad blockers), games, and business and educational applications (e.g., word processing, spreadsheets and money management). In general, computer applications cannot easily be modified after these applications have been introduced into the consumer marketplace, other than what the original programmers have written into the applications to be modifiable. Consequently, the end users cannot usually add new features and/or new operations to the computer applications that were not contemplated by the original programmers.

Furthermore, computer applications typically do not allow a user to write simple codes that can be used to control one or more aspects of the applications. One exception to this typical limitation is an Internet browser, which can read an HTML document and create a web page. As an example, using JavaScript programming language, a user can control different aspects of the resulting web page by embedding a JavaScript into an HTML document. Since a JavaScript is written into an HTML document, the JavaScript is part of and is dependent on the HTML document. A JavaScript can be used to add functionalities to a web page, such as image rollovers, form validations, and control elements on the webpage.

However, there is no such mechanism to write simple codes to control other types of computer applications. Thus, there is no way to control any aspect of a computer operating environment provided by, for example, a word processing application by writing a simple code and running that code.

In view of these concerns, there is a need for a system and method for controlling a computer operating environment, such as an environment provided by a computer application, using a simple code that can be written by an end user.

### SUMMARY OF THE INVENTION

A system and method for controlling a computer operating environment utilizes a non-executable computer program that is dependent on a primary computer program, which provides the computer operating environment. The non-executable computer program is a compiled computer program that is based on a custom scripting programming language. The non-executable computer program can be configured to control various aspects of the computer operating environment using a bytecode interpreter of the primary computer program, including any object that can exist in the computer operating environment.

A system in accordance with an embodiment of the invention comprises a primary computer program including a bytecode interpreter, and a non-executable dependent computer program that can control an object in the computer operating environment. The primary computer program provides the computer operating environment. The non-executable dependent computer program is a scripting language-based computer program including bytecodes that correspond to specific tasks to be performed by the primary computer program. The bytecode interpreter of the primary computer program is configured to correlate the bytecodes of the non-executable dependent program and the specific tasks.

A method in accordance with an embodiment of the invention comprises running a primary computer program including a bytecode interpreter and running a non-executable dependent computer program that can control an object in the computer operating environment.

An embodiment of the invention includes a storage medium, readable by a computer, tangibly embodying a program of instructions executable by the computer to perform method steps for controlling a computer operating environment.

Other aspects and advantages of the present invention will become apparent from the following detailed description, taken in conjunction with the accompanying drawings, illustrated by way of example of the principles of the invention.

### BRIEF DESCRIPTION OF THE DRAWINGS

FIG. 1 shows a process for creating an Object Interaction and Modification (OIAM) program in accordance with an embodiment of the invention.

FIG. 2 is a block diagram of a computer system having an OIAM program and a Blackspace program in accordance with an embodiment of the invention.

FIG. 3 shows a single-page mode print area rectangle (PAR) in a Blackspace environment in accordance with an embodiment of the invention.

FIG. 4 shows a multi-page mode PAR in a Blackspace environment in accordance with an embodiment of the invention.

FIG. 5 shows a multi-page mode PAR in a [Virtual or Visual] Display and Control Canvas (VDACC) object in accordance with an embodiment of the invention.

FIGS. 6A-6C show different printing sequences that can be selected using an arrow logic and context in accordance with an embodiment of the invention.

FIG. 7 is a flow diagram of a process for inserting and modifying recurring graphic objects in accordance with an embodiment of the invention.

FIG. 8 shows recurring graphic objects in selected rectangles of a multi-page mode PAR with a common original content in accordance with an embodiment of the invention.

FIG. 9 shows the multi-page mode PAR of FIG. 7 in which the contents of the recurring graphic objects in the selected rectangles have been collectively changed in response to a content change in one of the recurring graphic objects in accordance with an embodiment of the invention.

FIG. 10 is a flow diagram of a method for controlling a computer operating environment, such as the Blackspace environment, in accordance with an embodiment of the invention.

### DETAILED DESCRIPTION

A system and method for controlling a computer operating environment in accordance with an embodiment of the invention uses a custom scripting programming language, which allows a user to create a scripting language-based computer program to control the computer operating environment. The custom scripting programming language is referred to herein as the “Object Interaction and Modification” (OIAM) programming language. The computer operating environment may be any computer environment, such as a desktop environment provided by an operating system or a computing environment provided by a computer program running in a computer system. The scripting language-based computer program created using the OIAM programming language can be used to provide additional functionalities to the computer operating environment.

The system and method is described below with respect to a computer operating environment referred to herein as the “Blackspace” environment. The word “Blackspace” is a trademark of the NBOR Corporation. The Blackspace environment presents one universal drawing surface that is shared by all graphic objects within the environment. The Blackspace environment is analogous to a giant drawing “canvas” on which all graphic objects generated in the environment exist and can be applied. Each of these graphic objects can have a user-created relationship to any or all the other objects. There are no barriers between any of the objects that are created for or exist on this canvas. However, the invention is not limited to the Blackspace environment and can be implemented in any computer operating environment, such as a word processing application environment.

As used herein, the term “objects” include recognized graphic objects (e.g., stars, squares, circles, arrows, etc.), free drawn objects (sketches, drawings, lines, etc.), pictures in various file format (.png, .jpg, .bmp, .gif, etc.), graphic control devices (switches, faders, knobs, joysticks, etc.), videos in various file format (.mpg, .avi, .mov, etc.), text, and other graphic objects that are displayed on a display device.

Using the OIAM programming language, a computer program (“an OIAM program”) can be written that can virtually control any aspect of the Blackspace environment. An OIAM program is a computer program that is dependent on the controlled computer environment. An OIAM program can be initiated by a user or the computer program generating the computer operating environment to be controlled, such as a Blackspace program that generates the Blackspace environment. As described in more detail below, an OIAM program is produced by writing a computer code in the OIAM programming language and then compiling the code using a compiler with a custom lookup dictionary composed of bytecodes. The OIAM program can then be initiated by the Blackspace program or a user of the Blackspace program. An OIAM program is repeatedly executed, for example, every 1/30 of a second, as described in more detail below, which allows performance currently seen only in video games and fast graphical applications.

An OIAM program can be written to create any graphic object in the Blackspace environment that can be created in that environment, such as stars, rectangles, graphic control device, lines, etc. In addition, an OIAM program can be written to create graphic objects that cannot currently be created in the Blackspace environment by the Blackspace program. This concept is described in more detail below. In addition, the position of a graphic object being created (i.e., the position of the graphic object on a display screen) can be specified by the OIAM program, as well as any attribute of the graphic object, such as size and color. Furthermore, the position of a displayed graphic object can be changed by the OIAM program.

As an example, an OIAM program can be written to incrementally change the position of a graphic object on the screen by one horizontal pixel at each screen refresh. In this situation, the repeated execution of the OIAM program can be set to coincide with the screen refresh. Such an OIAM program would have the effect of horizontally scrolling the graphic object across the screen. As another example, an OIAM program can be written to loop through all graphic objects on the screen and decrease the size of the objects by one pixel increment at each screen refresh. This would have the effect of continuously reducing the sizes of the graphic objects on the screen until the objects disappear from the screen, giving the appearance of all the objects shrinking into nothing.

Other operations that can be performed in the Blackspace environment by using an OIAM program include checking to see if a graphic object has collided with another graphic object on the screen and modifying any attribute of a graphic object on the screen. However, as stated earlier, an OIAM program can be used to control virtually any aspect of the Blackspace environment, including performing operations that do not involve graphic objects or other graphic elements. As an example, an OIAM program can be used to open and read files, including extracting the contents of the files into the Blackspace environment. A more concrete example would be an OIAM program that can open a file from a spreadsheet program, read the contents of the file, and then create a spreadsheet with the contents of the file in the Blackspace environment.

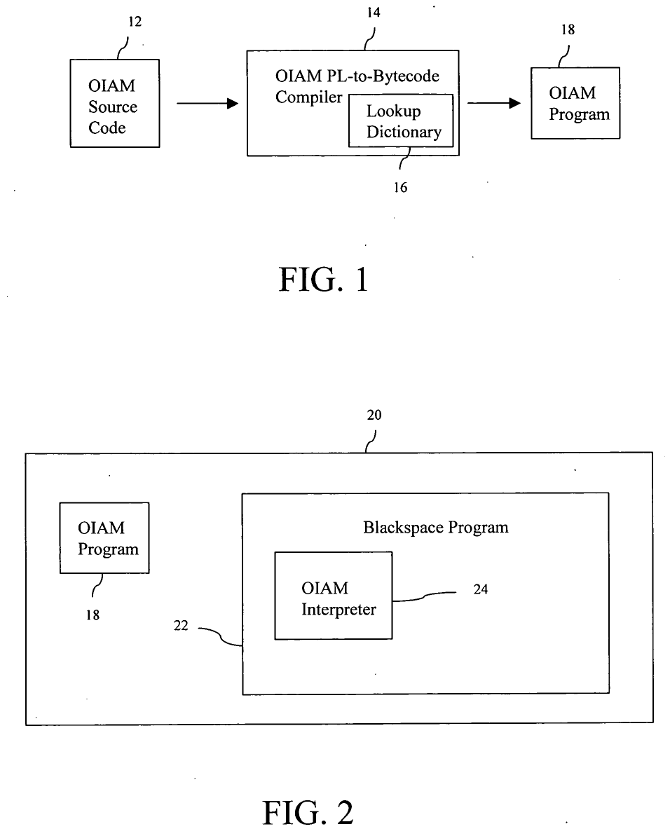

FIG. 1 illustrates the process for creating an OIAM program in accordance with the invention. First, a source code 12 for the OIAM program to be created is written in the OIAM programming language. The OIAM source code 12 includes control characters and value characters. Control characters are predefined textual and/or numeric characters that correspond to functions that will be executed by the controlled program, i.e., the Blackspace program. These control characters can be viewed as words that correspond to desired functions to be performed. Value characters are textual and/or numeric characters that are used to set text objects and variables. The source code 12 can be written using any text editor or word processing program. Since the Blackspace environment allows for creating text, the source code 12 may even be written in the Blackspace environment. As stated above, the OIAM programming language is a scripting language. Thus, the source code 12 is readily understandable by a reader with little or no knowledge of computer programming. The following is an example of a source code written in the OIAM programming language to illustrate the simplicity of using the OIAM programming language.

| | | |
|---|---|---|
| | LOADOBJECT | TEXTOBJECT |
| | SET TEXT | “This is an example” |
| | SET XY | 50,50 |
| LOOP: | MOV | XPOS,1 |
| | STOP | |
| | JLE | XPOS,800,LOOP |
| | DELETEOBJECT | |
| | EXIT | |

The above source code, when compiled and executed, will load a text object of “This is an example” and position the text object at X and Y coordinates on the screen defined by “50,50”. At each running of the complied code, the text object will be moved by one pixel in the positive X direction until the object reaches a certain X position (i.e., 800) and then the object is deleted. Thus, this source code will have the effect of creating a text object at an initial position and then horizontally moving that object until the object reaches a final position, where the object disappears.

After the source code 12 is written, the code is compiled by an OIAM program language (PL)-to-bytecode compiler 14, referred to herein as the “OIAM compiler”. The OIAM compiler 14 is designed to read the source code 12 and convert the code into bytecodes for control characters. The conversion of control characters into bytecodes involves using a custom lookup dictionary 16 that equates particular control characters to binary values in a predefined range (e.g., [0, 255]). Each binary value represents one or more instructions that will be executed by the Blackspace program. The OIAM compiler 14 also converts each of the value characters in the source code 12 into a corresponding binary value, which represents a specific alphanumeric character.

The compilation of the source code 12 by the OIAM compiler 14 using the lookup dictionary 16 results in an OIAM program 18. The OIAM program 18 can then be loaded into a computer system and executed to control some aspect of a computer operating environment, such as the Blackspace environment. The OIAM program 18 is not an executable, and thus, cannot be independently executed. The OIAM program 18 is dependent on a primary program, which provides the controllable computer operating environment. As described below, the primary program must include a bytecode interpreter the can correlate the bytecodes of an OIAM program to corresponding instructions or tasks to be performed by the primary program. The OIAM program 18 can be distributed to other users of the primary program, such as the Blackspace program, so that those users can run the OIAM program on their systems.

Turning now to FIG. 2, a block diagram of a computer system 20 having the OIAM program 18 and a Blackspace program 22 (the primary program with respect to the OIAM program) in accordance with an embodiment of the invention is shown. The functionality of the OIAM program 18 depends on the written source code of the program. As state above, an OIAM program can be created to control any aspect of a computer operating environment, which is provided by the primary program. In the computer system 20, the OIAM program 18 can be activated automatically by the Blackspace program 22. As an example, the Blackspace program 22 of the computer system 20 may be configured to activate the OIAM program 18 when the Blackspace program is launched. The OIAM program 18 can also be activated by a user via the Blackspace program 22 of the computer system 20. As an example, a user of the Blackspace program 22 may activate the OIAM program 18 by entering one or more appropriate commands using a graphic control device, such as a switch, or turning on one or more entries of a menu. As described in more detail below, the OIAM program 18 is typically executed repeatedly when activated. As an example, the OIAM program 18 may be executed repeatedly by the Blackspace program 22 using a thread, which is used to call forth the OIAM program again and again with predefined timing (or cycle).

In order for the OIAM program 18 to properly run, the primary program (e.g., the Blackspace program 22) needs to have an OIAM bytecode interpreter 24 that can understand instructions associated with the bytecodes of the compiled OIAM program 18. The OIAM interpreter 24 is part of the Blackspace program 22 and can direct the Blackspace program to execute any function that the Blackspace program can perform. In addition, the OIAM interpreter 24 can be configured to directly execute one or more functions that the Blackspace program 22 cannot perform. For such a function, all the necessary codes to execute that function are written into the OIAM interpreter 24. When the OIAM interpreter 24 is called to perform such a function, the OIAM interpreter reads the bytecode and then executes the function associated with the bytecode, instead of directing the Blackspace program 22 to perform that function.

Since there is an association between the tasks to be performed by the OIAM interpreter 24 and the bytecodes of the compiled OIAM program 18, there is also an association between these tasks and the control characters in the original source code 12 of the OIAM program via the lookup dictionary 16 of the OIAM compiler 14. The following list is an example of such association between control (instruction) characters used in OIAM source codes and the corresponding tasks preformed by the OIAM interpreter 24.
UPDATEOBECT—updates a graphic object's information in the Blackspace program, e.g., X and Y positions.
NAME—gives the OIAM program a name so that the OIAM program can be referenced later.
SET—sets a value to a variable. For example, “SET MYVAR, 10” would specify a value of 10 for the variable MYVAR.
STOP—stops processing the OIAM program for this cycle.
JMP—jumps to another location in the OIAM program.
JLT—jumps if the current value is less than the prescribed value. For example, “JLT XPOS,100,SKIPTHIS” would tell the interpreter to jump if X position is less than 100.
JLE—jumps if the current value is less than or equal to the prescribed value. For example, “JLE XPOS,100,SKIPTHIS” would tell the interpreter to jump if X position is less than or equal to 100.
JEQ—jumps if the current value is equal to the prescribed value.
JGT—jumps if the current value is greater than the prescribed value.
JGE—jumps if the current value is greater than or equal to the prescribed value.
JNE—jumps if the current value is not equal to the prescribed value.
ADD—adds a value or variable to a variable. For example, “ADD XPOS, 10” would add 10 pixels to the variable XPOS.
SUB—subtracts a value or variable from a variable.
LOADOIAM—loads another OIAM program. For example, “LOADOIAM printer.oiam” would load a “printer” OIAM program.

This list illustrates the relationship between the control characters in OIAM source codes and the tasks performed by the OIAM interpreter 24 of the Blackspace program 22 when the source code is compiled into an OIAM program and then executed. The above list is just a small sample of possible control characters and the corresponding interpreter tasks. There can be hundreds, or even thousands or more, of different control characters that correspond to different tasks that the OIAM interpreter 24 can execute, which are only limited by the computer system 20 in which the OIAM program 18 and the Blackspace program 22 are executed.

As mentioned above, each of these control characters is assigned to a specific bytecode by the OIAM compiler 14 using the lookup dictionary 16. That bytecode is then recognized by the OIAM interpreter 24 of the Blackspace program 22 when the OIAM program 18 is executed. In response to the particular bytecode, the OIAM interpreter 24 performs the task or tasks associated with that particular bytecode. The ultimate actions associated with the bytecodes are carried out by the Blackspace program 22 or by the OIAM interpreter 24.

The compiled OIAM programs can be created to perform virtually any type of operations within the Blackspace environment or other computer operating environments, such as allowing communications between networked computers that can be used for playing games on-line or for enabling instant messaging. However, a particular type of operation within the Blackspace environment of interest is inserting recurring graphic objects in “pages” of a document. This operation is similar to inserting headers and/or footers in an electronic document using a conventional word processing application. However, unlike conventional word processing applications that limit the page area in which to insert headers and footers, the use of a special OIAM program allows headers and footers to be inserted anywhere on selected pages of a document.

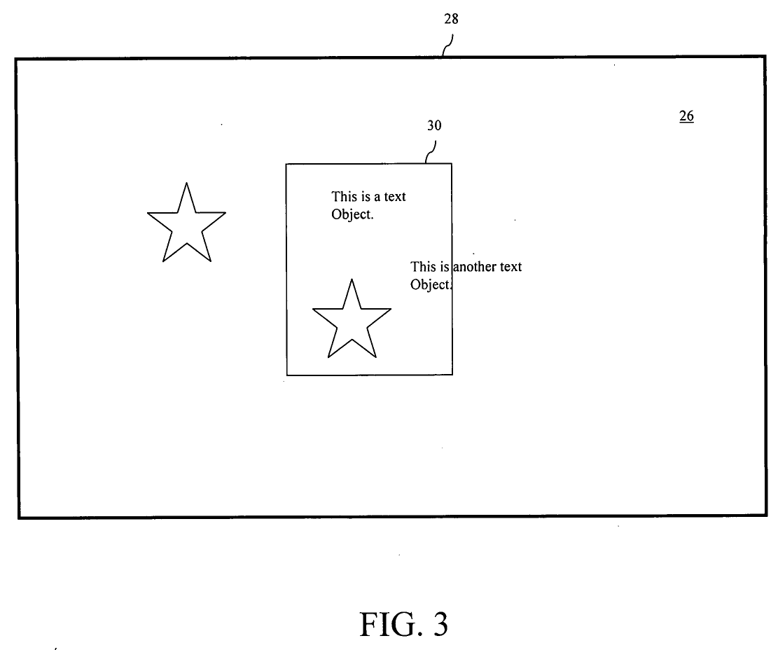

As illustrated in FIG. 3, in a Blackspace environment 26, a user is able to print a selected area displayed on a computer screen 28 by creating a single-page mode print area rectangle (PAR) 30. The single-page mode PAR 30 is user-definable with respect to position and size. Thus, the single-page mode PAR 30 can be moved to intersect any of the displayed objects. When the single-page mode PAR 30 is initiated for printing, displayed objects and portions of displayed objects that are within the perimeter of the PAR are printed. The PAR 30 represents the actual printable area that a printer can print on a sheet of paper. Since this actual printable area is fixed, the printed scale of the displayed objects and the portions of the displayed objects will depend on the size of the PAR 30.

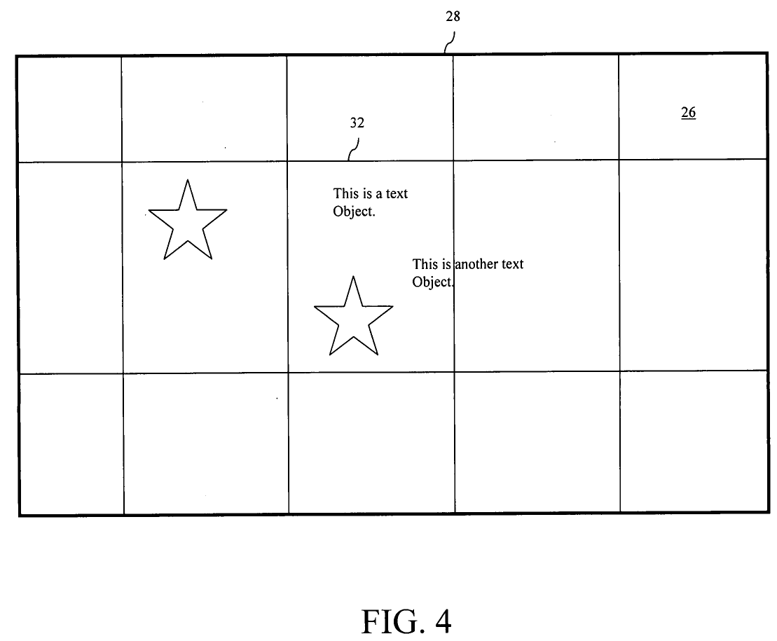

In the Blackspace environment 26, a user is also able to print multiple pages using a multi-page mode PAR 32, which is shown in FIG. 4. The multi-page mode PAR 32 is an array of rectangles, wherein each rectangle corresponds to a page to be printed. Similar to the single-page mode PAR 30, each rectangle of the multi-page mode PAR 32 represents the actual printable area of a sheet of paper when the multi-page mode PAR is initiated for printing. These rectangles of the multi-page mode PAR can be collectively changed in size and collectively moved in the Blackspace environment 26 to control the displayed areas that will be printed on different pages. For more information about the single-page and multi-page mode PARs, see pending U.S. patent application entitled “Graphic User Interface and Method for Selectively Printing Objects Displayed on a Display Device” Ser. No. 10/672,404, filed on Sep. 26, 2003, which is incorporated by reference herein.

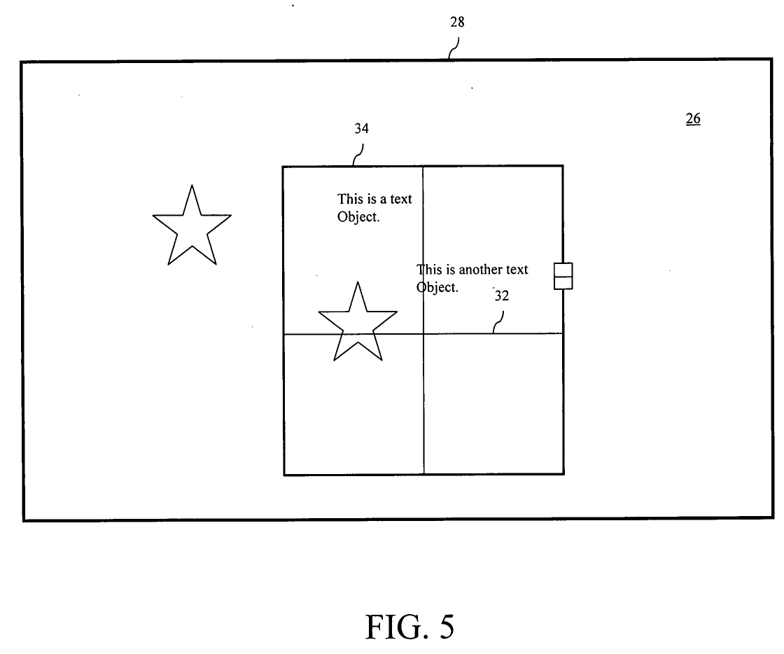

As shown in FIG. 5, the multi-page mode PAR 32 can also be used in a [Virtual or Visual] Display and Control Canvas (VDACC) object 34. The term “VDACC” is a trademark of NBOR Corporation. A VDACC object includes a workspace surface or canvas that may be larger than the visible or viewable area of the VDACC object. Thus, a VDACC object allows a user to scroll the visible area to view graphic objects or contents in the VDACC object that were hidden from the visible area. However, the objects that appear to be in the VDACC object exist on the global Blackspace canvas. For more information about VDACC objects, see pending U.S. patent application Ser. No. 10/671,953, entitled “Intuitive Graphic User Interface with Universal Tools”, filed Sep. 26, 2003, which is incorporated by reference herein.

Using a special compiled OIAM program (referred to herein as the “printing OIAM program”), user-defined graphic object (referred to herein as the “recurring graphic object”) can be inserted into one of the rectangles or “print areas” of the multi-page mode PAR 32 such that the same graphic object selectively appears in other selected rectangles of the multi-page mode PAR. The recurring graphic object can include text, numbers, pictures or any graphics that can be displayed in the Blackspace environment 26, e.g., the workspace canvas of the VDACC object 34. The recurring graphic object can be used to selectively insert headers and/or footers into pages of an electronic document, which are represented on the screen 28 as rectangles of the multi-page mode PAR 32. However, unlike conventional word processing applications, headers and footers in the form of recurring graphic objects can be placed anywhere on a page. Thus, the recurring graphic objects created using the printing OIAM program provides more flexibility and control for the user to insert text and other graphic objects in selected pages of a document. This functionality of selectively inserting recurring graphic objects in the print areas of the multi-page mode PAR 32 is part of a feature referred to herein as the recurring graphic object feature.

As an example, the following exemplary OIAM source code can be used to create the printing OIAM program to enable the recurring graphic object feature in a Blackspace environment.

| CONTROLDATANAME PAGES | | | (1) |
|---|---|---|---|
| | LOADOBJECT | TEXTCONTROL | (2) |
| | SET TEXTCONTROL | “enter text here” | (3) |
| LOOPSTART: | PSET | | (4) |
| | STOP | | (5) |
| | JMP LOOPSTART | | (6) |

The line numbers “(1)” to “(6)” are not part of the source code. These numbers are used herein for reference. Brief explanation of the above source code (when compiled and ran) is now presented. The line (1) of the source code “CONTROLDATANAME PAGES” names this program as “PAGES” so that the printing OIAM program can be called by other programs, including another printing OIAM program. The line (2) of the source code loads an object called “TEXTCONTROL”, which is a text object and will be the recurring graphic object. The line (3) of the source code “SET TEXTCONTROL” enter text here“ ” inserts the text “enter text here” in the TEXTCONTROL so that a user can enter the desired text for the recurring graphic object.

The “LOOPSTART” on the line (4) of the source code is used to mark the line (4) for reference. The “PSET” on the line (4) instructs the OIAM interpreter to perform two tasks. One of these two tasks is checking to see if the text of the TEXTCONTROL has changed with any respect, such as content, size or color. If the textual content has changed, then the text for all selected pages in which the recurring graphic object is to be inserted are correspondingly changed. The second task is checking to see if the multi-page mode PAR has changed with respect to size or position, which would correspond to a collective change in the size or position of all the printable areas for the different pages. If the multi-page mode PAR has changed in size or position, then the text for all selected pages in which the recurring graphic object is inserted are correspondingly changed.

The “STOP” on line (5) of the source code stops the processing of the printing OIAM program for the current cycle. In the next cycle when the printing OIAM program is again activated, the processing of the printing OIAM program starts at the following line of the program. The “JMP LOOPSTART” on the line (6) jumps the processing of the printing OIAM program to the line of the source code having the reference “LOOPSTART”, which is the line (4) of the source code. The tasks associated with the “PSET” is then again performed by the OIAM interpreter.

As stated above, the printing OIAM program is used the enable the recurring graphic object feature of the Blackspace program. In the Blackspace environment, a user can activate the recurring graphic object feature by entering an appropriate command, e.g., selecting an entry in a menu, when the multi-page mode PAR is the screen. When the recurring graphic object feature is activated, a printing OIAM program is initiated for each print area of the multi-page mode PAR in which the recurring graphic objects is to be inserted. The user can select the print areas in which the recurring graphic objects are to be inserted by entering another command, e.g., selecting another entry in the menu. For example, the choices presented to the user for selection may include:
1) insert the recurring graphic object only in the current print area of the multi-page mode PAR, i.e., the print area in which the cursor is currently positioned or otherwise selected;
2) insert the recurring graphic objects in the current print area of the multi-page mode PAR and all print areas before the current print area;
3) insert the recurring graphic objects in the current print area of the multi-page mode PAR and all print areas after the current print area; and
4) insert the recurring graphic objects in selected print areas of the multi-page mode PAR.

The sequential order of the print areas of the multi-page mode PAR is user-definable in the Blackspace environment. This sequential order corresponds to the order in which pages of the multi-page mode PAR are to be printed. In the exemplary embodiment, arrow logic and context may be used to select the printing sequence of contents within the rectangles or “pages” of the multi-page mode PAR. In the Blackspace environment, an arrow of a predefined color can be used to execute a predetermined function. In addition, the predetermined function can be dependent on the context in which the arrow is being used. The context is an arrow of predefined color (e.g., yellow) drawn in the multi-page mode PAR. For more information regarding arrow logic and context, see pending U.S. patent application Ser. No. 09/880,397, which is incorporated herein by reference.

As an example, using the described arrow logic and context, the printing sequence for the pages of the multi-page mode PAR 32 can be selected by a user by drawing a yellow arrow that intersects a set of four complete rectangles of the multi-page mode PAR at the uppermost right hand corner of the screen 28 (see FIG. 4) or the VDACC object 34 (see FIG. 5). The term “intersect” as used herein means that the arrow contacts any portion of a rectangle of the multi-page mode PAR 32, such as the boundary of that rectangle. The order in which the arrow intersects, for example, the four rectangles of the multi-page mode PAR 32 will determine the printing sequence for all the rectangles of the multi-page mode PAR.

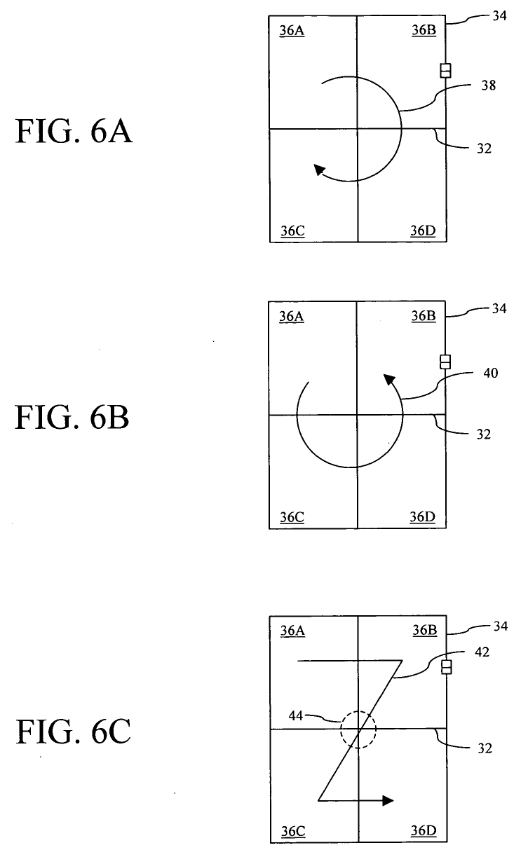

Three exemplary printing sequence selections using an arrow logic and context are now described with reference to FIGS. 6A, 6B and 6C. In FIGS. 6A-6C, the multi-page mode PAR 32 in the VDACC object 34 is shown. The multi-page mode PAR 32 includes rectangles 36A, 36B, 36C and 36D. As illustrated in FIG. 6A, if a clockwise arrow 38 is drawn from the rectangle 36A of the multi-page mode PAR 32 that intersects the four rectangles 36A-36D of the multi-page mode PAR, then the printing sequence will be defined in the following order: the rectangle 36A, the rectangle 36B, the rectangle 36D and the rectangle 36C. As illustrated in FIG. 6B, if a counterclockwise arrow 40 is drawn from the rectangle 36A of the multi-page mode PAR 32 that intersects the four rectangles 36A-36D of the multi-page mode PAR, then the printing sequence will be defined in the following order: the rectangle 36A, the rectangle 36C, the rectangle 36D and the rectangle 36B. As illustrated in FIG. 6C, if a Z-shaped arrow 42 is drawn from the rectangle 36A of the multi-page mode PAR 32 that intersects the four rectangles 36A-36D of the multi-page mode PAR, then the printing sequence will be defined in the following order: the rectangle 36A, the rectangle 36B, the rectangle 36C and the rectangle 36D. In order to allow a user to easily draw the diagonal portion of the arrow 42 such that the arrow intersects the rectangle 36B and then the rectangle 36C, an area 44 at the intersection of the four rectangles 36A-36D may be programmed such that an arrow logic is not recognized in this area. Thus, the arrow 42 is not interpreted as intersecting the rectangle 36D after the rectangle 36B since the arrow first intersects the rectangle 36D in the area 44.

The selected printing sequence can also be applied to the remaining rectangles of the multi-page mode PAR 32 in sets of four rectangles. As an example, if there are additional rectangles of the multi-page mode PAR 32 below the four rectangles 36A-36D, the same printing sequence will be applied to those rectangles in sets of four rectangles. Similarly, if there are additional rectangles of the multi-page mode PAR 32 to the right of the four rectangles 36A-36D, the same printing sequence will be applied to those rectangles in sets of four rectangles. If there are additional rectangles below and to the right of the four rectangles 36A-36D of the multi-page mode PAR 32, the selected the printing sequence can be applied in sets of four rectangles in a raster scanning pattern. The scanning pattern applied to the rectangles of the multi-page mode PAR 32 for the selected printing sequence may be user definable. By selecting a custom printing sequence and the rectangles of the multi-page mode PAR for placing the recurring graphic object, a user can control which printed pages of a document will have the recurring graphic objects, for example, every third printed page.

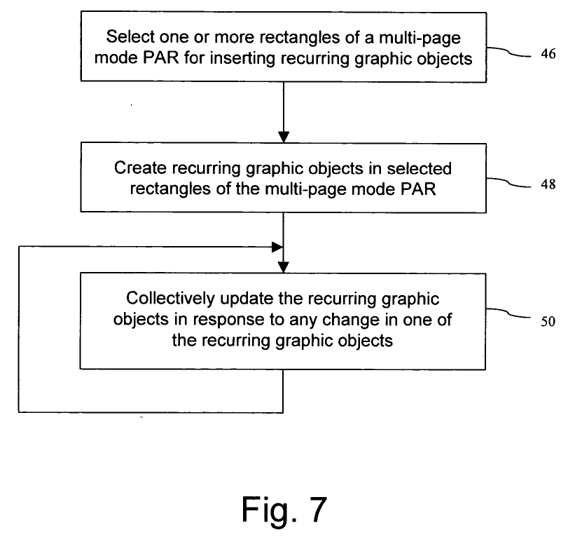

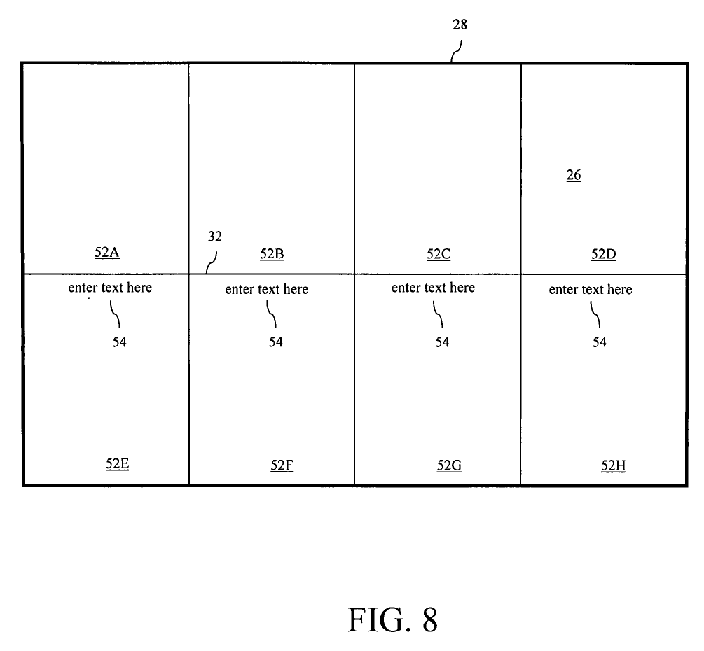

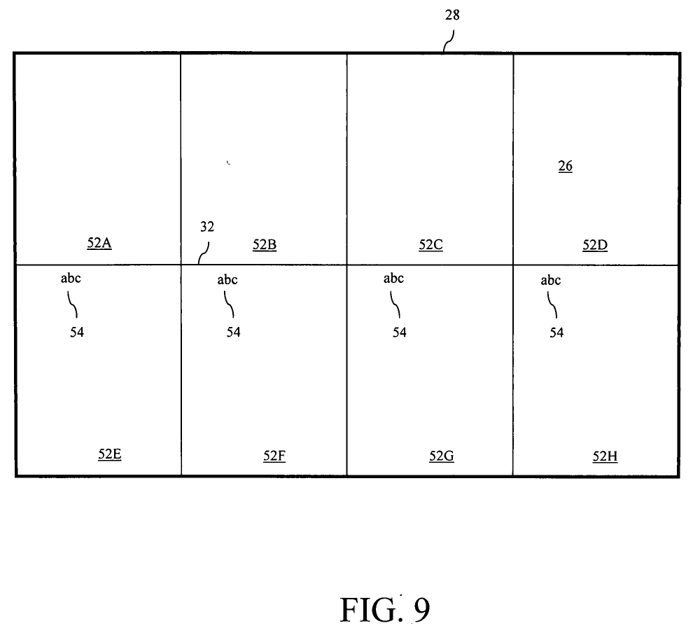

The process for inserting and modifying recurring graphic objects in accordance with an embodiment of the invention is now described with reference to the flow diagram of FIG. 7 and the multi-page mode PAR 32 shown in FIGS. 8 and 9. The multi-page mode PAR 32 shown in FIGS. 8 and 9 include eight rectangles 52A, 52B, 52C, 52D, 52E, 52F, 52G and 52H. The rectangles 52E-52H of the multi-page mode PAR 32 include recurring graphic objects 54. The process begins at block 46, where one or more rectangles of a multi-page mode PAR are selected for inserting recurring graphic objects. As an example, the rectangles 52E-52H of the multi-page mode PAR 32 may be selected. The selecting of rectangles of a multi-page mode PAR for inserting recurring graphic objects initiates the printing OIAM program for the selected rectangles of the multi-page mode PAR. The printing OIAM program is sequentially executed for each of the selected rectangles of the multi-page mode PAR and then repeated in a continuous fashion. As described below, if any change in the content or position of a single recurring graphic object in the selected rectangles of the multi-page mode PAR is detected, the detected change is applied to all the other recurring graphic objects in the selected rectangles of the multi-page mode PAR.

Next, at block 48, recurring graphic objects in the form of text objects are created at each of the selected rectangles of the multi-page mode PAR text object by the sequential execution of the printing OIAM program. The contents of the recurring graphic objects may be blank so that a user can enter a desired text or other graphics. Alternatively, the recurring graphic objects may include a common original content. As an example, the common original content may be the text “enter text here”, as illustrated in FIG. 8.

Next, at block 50, the recurring graphic objects in the selected rectangles of the multi-page mode PAR are collectively updated in response to any change in one of the recurring graphic objects. These changes may include any change to the contents of the recurring graphic objects, such as text change, font change, font size change and font color change, and positional change within the respective rectangle of the multi-page mode PAR. In addition, the changes may include any change to the multi-page mode PAR, such as positional change or size change (these changes affect the recurring graphic objects with respect to size and position). As an example, in FIG. 9, the contents of the recurring graphic object 54 in the rectangle 52G of the multi-page mode PAR 32 has been changed from “enter text here” to “abc”. In response to this change, the contents of the recurring graphic objects 54 in the rectangles 52E, 52F and 52H of the multi-page mode PAR 32 have been collectively changed, as illustrated in FIG. 9. In a similar fashion, if the contents of the recurring graphic object in any selected rectangles 52E-52H of the multi-page mode PAR 32 is changed, this change is reflected in the recurring graphic objects of the other selected rectangles. Thus, the recurring graphic objects of the selected rectangles of a multi-page mode PAR are maintained to be identical for the respective selected rectangles by the printing OIAM program.

As stated above, the printing OIAM program is continuously and serially executed in cycles for the selected rectangles of a multi-page mode PAR. Thus, the process then proceeds back to block 50, where the recurring graphic objects are again collectively updated in response to any visual change in one of the recurring graphic objects. As an example, the printing OIAM program is executed every 1/30 of a second. In this example, if there are four selected rectangles of a multi-page mode PAR, the printing OIAM program is executed for all the selected rectangles in 4/30 of a second. Every time the printing OIAM program is executed, the OIAM interpreter 16 of the Blackspace program 22 (shown in FIG. 2) checks for any change in the visual aspects for that recurring graphic object. If there are any changes, then these changes are applied to all other recurring graphic objects by the Blackspace program 22 via the OIAM interpreter 16.

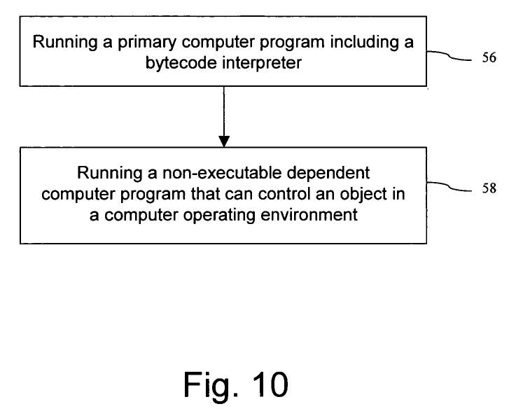

A method for controlling a computer operating environment, such as the Blackspace environment, in accordance with an embodiment of the invention is described with reference to the flow diagram of FIG. 10. The method includes running a primary computer program including a bytecode interpreter, at block 56. The primary computer program provides the computer operating environment, such as the Blackspace environment. The method also includes running a non-executable dependent computer program that can control an object in the computer operating environment, at block 58. The dependent computer program is a scripting language-based computer program that includes bytecodes, which correspond to specific tasks to be performed by the primary computer program. The bytecode interpreter of the primary computer program is configured to correlate the bytecodes of the dependent program and the specific tasks to be performed.

Although specific embodiments of the invention have been described and illustrated, the invention is not to be limited to the specific forms or arrangements of parts so described and illustrated. The scope of the invention is to be defined by the claims appended hereto and their equivalents.

1. A method for controlling a computer operating environment, said method comprising:
running a primary computer program including a bytecode interpreter, said primary computer program providing said computer operating environment; and
running a non-executable dependent computer program that can control an object in said computer operating environment, said non-executable dependent computer program being a scripting language-based computer program including bytecodes that correspond to specific tasks to be performed by said primary computer program, said bytecode interpreter of said primary computer program being configured to correlate said bytecodes of said non-executable dependent program and said specific tasks.

2. The method of claim 1 further comprising directing said primary computer program to perform a particular task of said specific tasks in response to a corresponding bytecode in said non-executable dependent computer program.

3. The method of claim 1 further comprising directing said bytecode interpreter of said primary computer program to perform a particular task of said specific tasks in response to a corresponding bytecode in said non-executable dependent computer program.

4. The method of claim 1 further comprising compiling a source code using a lookup dictionary to derive said non-executable dependent computer program, said source code including control words that correspond to said bytecodes of said non-executable dependent computer programs.

5. The method of claim 1 wherein said running of said non-executable dependent computer program includes repeatedly executing said non-executable dependent computer program to incrementally control said object in said computer operating environment control.

6. The method of claim 1 wherein said running of said non-executable dependent computer program includes controlling a visual attribute of said object.

7. The method of claim 1 wherein said running of said non-executable dependent computer program includes inserting recurring graphic objects in print areas that correspond to pages to be printed.

8. The method of claim 7 wherein said running of said non-executable dependent computer program further includes updating said recurring graphic objects in response to a visual change in one of said recurring graphic objects such that said visual change is reflected in each of said recurring graphic objects.

9. The method of claim 8 wherein said updating of said recurring graphic objects includes changing contents of said recurring graphic object in response to a content change in one of said recurring graphic objects.

10. The method of claim 8 wherein said updating of said recurring graphic objects includes changing relative positions of said recurring graphic objects within said print areas in response to a positional change of one of said recurring graphic objects within one of said print areas.

11. A storage medium readable by a computer, tangibly embodying a program of instructions executable by said computer to perform method steps for controlling a computer operating environment, said method steps comprising:
running a primary computer program including a bytecode interpreter, said primary computer program providing said computer operating environment; and
running a non-executable dependent computer program that can control an object in said computer operating environment, said non-executable dependent computer program being a scripting language-based computer program including bytecodes that correspond to specific tasks to be performed by said primary computer program, said bytecode interpreter of said primary computer program being configured to correlate said bytecodes of said non-executable dependent program and said specific tasks.

12. The storage medium of claim 11 further comprising directing said primary computer program to perform a particular task of said specific tasks in response to a corresponding bytecode in said non-executable dependent computer program.

13. The storage medium of claim 11 further comprising directing said bytecode interpreter of said primary computer program to perform a particular task of said specific tasks in response to a corresponding bytecode in said non-executable dependent computer program.

14. The storage medium of claim 11 further comprising compiling a source code using a lookup dictionary to derive said non-executable dependent computer program, said source code including control words that correspond to said bytecodes of said non-executable dependent computer programs.

15. The storage medium of claim 11 wherein said running of said non-executable dependent computer program includes repeatedly executing said non-executable dependent computer program to incrementally control said object in said computer operating environment control.

16. The storage medium of claim 11 wherein said running of said non-executable dependent computer program includes controlling a visual attribute of said object.

17. The storage medium of claim 11 wherein said running of said non-executable dependent computer program includes inserting recurring graphic objects in print areas that correspond to pages to be printed.

18. The storage medium of claim 17 wherein said running of said non-executable dependent computer program further includes updating said recurring graphic objects in response to a visual change in one of said recurring graphic objects such that said visual change is reflected in each of said recurring graphic objects.

19. The storage medium of claim 18 wherein said updating of said recurring graphic objects includes changing contents of said recurring graphic object in response to a content change in one of said recurring graphic objects.

20. The storage medium of claim 18 wherein said updating of said recurring graphic objects includes changing relative positions of said recurring graphic objects within said print areas in response to a positional change of one of said recurring graphic objects within one of said print areas.

21. A system for controlling a computer operating environment, said system comprising:
a primary computer program including a bytecode interpreter, said primary computer program providing said computer operating environment; and
a non-executable dependent computer program that can control an object in said computer operating environment, said non-executable dependent computer program being a scripting language-based computer program including bytecodes that correspond to specific tasks to be performed by said primary computer program, said bytecode interpreter of said primary computer program being configured to correlate said bytecodes of said non-executable dependent program and said specific tasks.

22. The system of claim 21 wherein said bytecode interpreter of said primary computer program is configured to direct said primary computer program to perform a particular task of said specific tasks in response to a corresponding bytecode in said non-executable dependent computer program.

23. The system of claim 21 wherein said bytecode interpreter of said primary computer program is configured to directly perform a particular task of said specific tasks in response to a corresponding bytecode in said non-executable dependent computer program.

24. The system of claim 21 wherein said non-executable dependent computer program is a compiled computer program.

25. The system of claim 21 wherein said primary computer program is configured to repeatedly execute said non-executable dependent computer program to incrementally control said object in said computer operating environment control.

26. The system of claim 21 wherein said non-executable dependent computer program is configured to control a visual attribute of said object.

27. The system of claim 21 wherein said non-executable dependent computer program is configured to insert recurring graphic objects in displayed print areas that correspond to pages to be printed.

28. The system of claim 27 wherein said non-executable dependent computer program is further configured to update said recurring graphic objects in response to a visual change in one of said recurring graphic objects such that said visual change is reflected in each of said recurring graphic objects.

29. The system of claim 28 wherein said non-executable dependent computer program is configured to change contents of said recurring graphic object in response to a content change in one of said recurring graphic objects.

30. The system of claim 28 wherein said non-executable dependent computer program is configured to change relative positions of said recurring graphic objects within said print areas in response to a positional change of one of said recurring graphic objects within one of said print areas.
